(19) United States
(12) Patent Application Publication
(10) Pub. No.: US 2009/0106406 A1
(43) Pub. Date: Apr. 23, 2009

(54) METHOD OF INITIATING DTMF DIAGNOSTICS AND OTHER FEATURES VIA A CALL IN DIAGNOSTICS INTERFACE

(75) Inventors: Marc R. Bernard, Miramar, FL (US); Jeffrey A. Noel, Leesburg, VA (US); Jeffrey Rosenwald, Frederick, MD (US); John A. Stock, Leesburg, VA (US); John T. Burch, McLean, VA (US)

Correspondence Address: FITZPATRICK CELLA (TELLABS), 30 ROCKEFELLER PLAZA, NEW YORK, NY, 10112-3800, US

(73) Assignee: TELLABS VIENNA, INC, Naperville, IL (US)

(21) Appl. No.: 11/877,189

(22) Filed: Oct. 23, 2007

(51) Int. Cl. G06F 15/16

(52) U.S. Cl. 709/223

(57) ABSTRACT

A method to initiate a remote diagnostic mode in a network terminal includes determining whether a received signal corresponds to a command to initiate a remote diagnostic mode, and setting the network terminal in a remote diagnostic mode in accordance with the result of the determining. An authentication procedure may be performed prior to setting the network terminal in the remote diagnostic mode, for increased security.

### BACKGROUND

1. Field

Example aspects of the present invention generally relate to diagnostic testing of a network terminal and, more particularly, to methods and apparatus to perform diagnostic testing of a network terminal involving access to remotely stored parameters.

2. Description of the Related Art

High bandwidth data is typically distributed over a high bandwidth channel, such as a fiber link, to a network terminal that provides an interface to a local area network (LAN). The network terminal includes an interface to receive data from the high bandwidth channel, as well as one or more interfaces for distributing data to a local network such as, for example, an Ethernet-based LAN and/or an in-home network for distribution of broadband video using coaxial cable. Configuration parameters for the network terminal are stored both locally at the network terminal and elsewhere on the network, e.g., at a central office. Data indicative of operating history (e.g., occurrence of alarm conditions, statistics regarding volume of data packets sent and received, etc.) may also be stored.

When a customer experiences a service problem, a service technician dispatched to the customer's location may enter a diagnostic mode to examine the current settings of network terminal parameters and/or the historical operating data, to determine the source of the problem and the appropriate corrective action. If necessary, the technician can modify parameters stored in the network terminal. The technician may interact with the network terminal using a DTMF interface and/or a POTS (plain old telephone service) interface, which the technician can use to enter commands to place the network terminal in a diagnostic mode and then to enter further commands to perform appropriate diagnostic routines. This conventional DTMF diagnostic interface only permits the technician to read and modify data stored locally at the network terminal.

The technician may also use the conventional DTMF interface to perform initial installation and registration of a network terminal. After a registration code is successfully entered at the network terminal using the DTMF interface, the network terminal communicates with a central office to transmit the registration information and to receive initial configuration information from the central office. After registration is completed, the registration function is disabled and the conventional DTMF interface does not permit the technician to initiate further communication with the central office or, in particular, to access any remotely stored diagnostic or configuration data.

### SUMMARY OF THE INVENTION

According to one example aspect of the present invention, a method to initiate a remote diagnostic mode in a network terminal is provided that includes determining whether a received signal corresponds to a command to initiate a remote diagnostic mode, and setting the network terminal in a remote diagnostic mode in accordance with the result of the determining.

According to another example aspect of the present invention, a method to perform diagnostics in a network terminal is provided that includes determining whether a diagnostic command received at the network terminal is a remote diagnostic command. If the received diagnostic command is determined to be a remote diagnostic command, then it is determined whether the network terminal is in a remote diagnostic mode and, if the network terminal is determined to be in the remote diagnostic mode, the received diagnostic command is transmitted to a central office.

According to a further example aspect of the present invention, a method to perform diagnostics for a network terminal is provided that includes inputting a command to initiate a remote diagnostic mode for the network terminal, inputting a diagnostic command to retrieve configuration data for the network terminal from a central office, and viewing displayed information representing the configuration data for the network terminal retrieved from the central office. According to yet a further example aspect of the invention, the method can include inputting a command to modify configuration data stored at the central office and inputting a new value to be stored at the central office.

According to yet another example aspect of the present invention, a network terminal is provided that includes a bridge to interface the network terminal with a data channel linking the network terminal to a central office, an interface to receive DTMF signals, and a processor. The processor (i) analyzes received DTMF signals, (ii) determines whether the received DTMF signals correspond to a command to initiate a remote diagnostic mode, and (iii) transmits the received DTMF signals to the central office via the bridge.

According to still another example aspect of the present invention, a method to collect diagnostic information for network terminals is provided that includes logging diagnostic commands input at a network terminal, and generating a report at a central office based on the logged diagnostic commands.

These and other example aspects of the present invention will be described in further detail below, with reference to the accompanying drawings.

### BRIEF DESCRIPTION OF THE DRAWINGS

FIG. 1 illustrates an example embodiment of a network terminal according to the present invention.

FIG. 2 illustrates an example embodiment of a procedure to initiate a remote diagnostic mode in a network terminal.

FIG. 3 further illustrates an example embodiment of a procedure to perform diagnostics in a network terminal.

FIG. 4 illustrates an example embodiment of a procedure to perform diagnostics for a network terminal.

FIG. 5 illustrates an example embodiment of a procedure to collect diagnostic information for network terminals.

### DETAILED DESCRIPTION

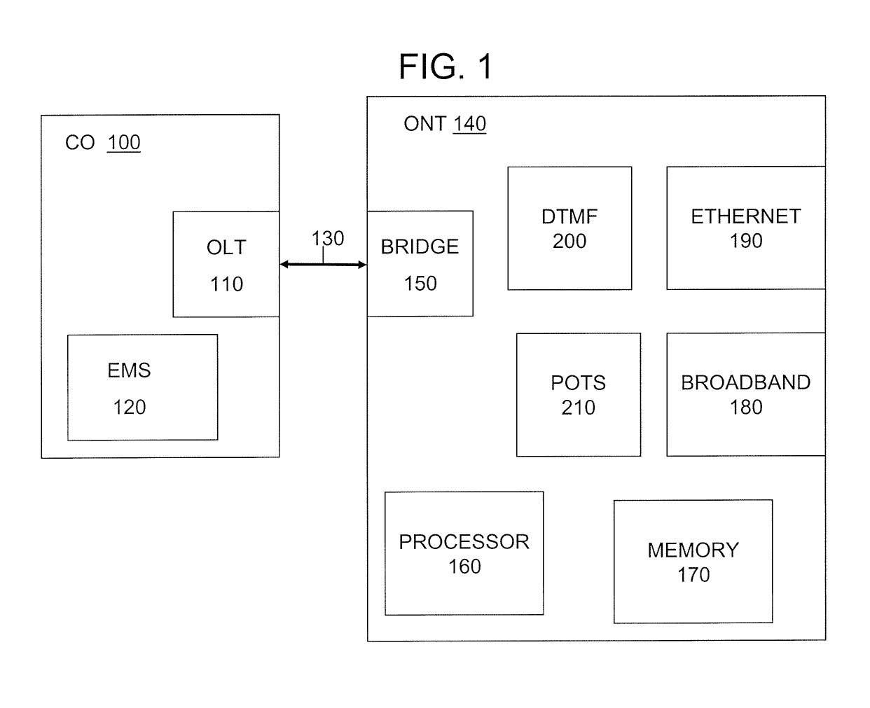

An example embodiment of the invention will be described with respect to FIG. 1. As shown in FIG. 1, a system for distributing data includes a central office 100, a data channel 130, and a network terminal 140. In this example embodiment, the data channel is a fiber link and the network terminal is an optical network terminal (ONT). However, those skilled in the art will appreciate that this is merely an example embodiment and the methods and apparatus described herein can be applied in environments other than optical networks.

Central office 100 includes an optical line terminal (OLT) 110 that can interface with plural data channels in communication with plural respective network terminals. The central office performs switching functions to manage the communication of data between service providers and end user locations where the respective network terminals are located. Although only one exemplary OLT is shown in FIG. 1, there may be many OLTs at a given central office. Central office 100 further includes an element management system (EMS) 120, which may be, for example, a server having a processor, memory, and software for performing management functions. EMS 120 configures and controls large numbers of network terminals and stores configuration parameters for network terminals.

Data channel 130 may include plural channels for communicating different types of data for different purposes. For example, there may be a primary data channel (which can be either analog or digital), a management channel such as an OMCI (OMT Management Control Interface) channel, and/or a dedicated channel for implementing a virtual local area network (VLAN).

ONT 140 includes a bridge 150 to interface the network terminal to data channel 130. ONT 140 also includes a processor 160 to control the network terminal and memory 170 for storing data. In this example embodiment, processor 160 is a microprocessor that executes firmware or software to perform control functions. However, processor 160 could be implemented by other hardware circuitry designed to perform the control functions, such as an ASIC, PAL, PLA, etc. Although, only a single memory 170 is depicted in FIG. 1, those skilled in the art will appreciate that there may be multiple memory devices and they may be of various types, including but not limited to RAM, ROM, floppy disk, hard drive, CD, DVD, and flash memory.

ONT 140 also includes several interfaces. In this example embodiment, ONT 140 includes a broadband interface 180 for distribution of broadband data (e.g., video) to an in-home network for use by an end user, an Ethernet interface 190, and a DTMF interface 200. The DTMF interface can be, for example, a touch pad integrated into ONT 140, or an interface for a technician to plug in a handset or other diagnostic tool for generating DTMF signals. ONT 140 also includes a POTS interface 210, which may include an RJ11 connector to which a telephone line may be connected. ONT 140 further includes a Wi-Fi interface 220 and a USB interface 230.

According to this example embodiment, a technician can initiate a remote diagnostic mode by inputting a predetermined sequence of DTMF signals to DTMF interface 200 of ONT 140. In particular, in this example embodiment the technician uses a handset that is plugged into the DTMF interface and has a keypad and a display (for example, a display such as the kind that displays dialed digits or caller ID information for an incoming signal). The predetermined sequence of DTMF signals in this example embodiment corresponds to the phone number 1.800.ONT.DIAG, but of course some other predetermined sequence can be used.

In this example embodiment, ONT 140 is configured to pass through (i.e., transmit without processing) the data entered using DTMF interface 200, via bridge 150 and data channel 130, to the central office. Software at central office 100 analyzes the input data and recognizes when the input data corresponds to the predetermined sequence to initiate the remote diagnostic mode. For example, the predetermined sequence of DTMF signals, or a representation thereof, may be stored in memory and the central office, and the signals received from the network terminal are sequentially compared to the stored signals to determine if there is a match for the entire predetermined sequence.

The software may reside on a backend server connected to an OLT, may be part of the EMS, or may otherwise be resident at the central office so as to receive and process the signals transmitted from the network terminal. If the software at central office 100 determines that received signals correspond to a command to initiate a remote diagnostic mode (i.e., the signals correspond to a predetermined sequence of DTMF signals), it executes a procedure to initiate a remote diagnostic mode. If security is not a concern, the central office can simply transmit a signal to the network terminal that is processed by processor 160 and causes it to set the network terminal in a remote diagnostic mode. For example, this may involve setting a predetermined flag or memory location to a predetermined value that indicates the network terminal is in the remote diagnostic mode.

However, to ensure better security, the software at the central server can initiate an authentication procedure. In this example embodiment, the authentication procedure involves prompting a service technician at the network terminal to enter a password. In particular, a message is sent to the display device on the handset being used by the service technician, such as a display used to display call ID information or phone numbers. The message prompts the technician to enter a password. The password is entered using a keypad and the received signals are transmitted from the network terminal to the central office to determine if the proper password was entered.

Multiple passwords can be used to provide even greater security. Also, the authentication procedure can take other forms. For example, the service technician may telephone the central office and provide verbal passwords and/or other information to confirm that they are authorized to use the remote diagnostic mode at a given network terminal. An operator at the central office can then send a command signal to a network terminal that permits access to the remote diagnostic mode. Further, the access can be limited to a single access unless further authorization is obtained, or the access can be limited in time. For example, the network terminal can be permitted access to the remote diagnostic mode only during a specific time window that corresponds to the time of a scheduled service call. One skilled in the art will further appreciate that the authentication procedure need not use the same type of input used to initiate the remote diagnostic mode, and that the authentication procedure can include inputs from multiple sources. For example, the authentication procedure could require a combination of entering a certain sequence of DTMF signals using a keypad, and also inputting a hexadecimal key from a flash memory device inserted into a USB interface on the network terminal.

If the authentication procedure is completed successfully, data is stored at the central office to indicate that the particular network terminal is set in the remote diagnostic mode, and the software at the central office causes a signal to be sent to the network terminal to set it in the remote diagnostic mode. In this manner, the central office and the network terminal are in synch as to whether the sequence to initiate the remote diagnostic mode has been entered.

In the example embodiment described above, the input DTMF signals are passed through to the central office and, if the signals correspond to a command to initiate a remote diagnostic mode and an authentication procedure is successfully completed, the central office transmits a signal to ONT 140 that is processed by processor 160 and causes the processor to set the network terminal in a remote diagnostic mode. Alternatively, ONT 140 can “snoop” the received DTMF signals that are passed through to the central office (e.g., store the signals locally as they are passed through). Processor 160 can then independently analyze those signals and determine whether the received signals correspond to a command to initiate a remote diagnostic mode. According to this alternative example, ONT 140 can be configured to permit processor 160 to set the network terminal in a remote diagnostic mode based on this determination, rather than based on a signal received from the central office. An authentication procedure, if required, can also be initiated by processor 160 rather than at the central office.

As yet another alternative example, rather than simply passing received DTMF signals through to the central office while snooping the data, ONT 140 may buffer the received DTMF signals and analyze them before transmitting them to the central office. In this alternative example, processor 160 determines whether the received signals correspond to a command to initiate the remote diagnostic mode. If so, processor 160 can set the network terminal in the remote diagnostic mode and pass the received signal on to the central office only if it determines that the received signals correspond to the command to initiate the remote diagnostic mode. Of course, processor 160 can perform an authentication procedure, if desired, prior to setting the network terminal in the remote diagnostic mode and passing the received DTMF signals on to the central office. Processor 160 can also transmit an indication that an authentication procedure has been successfully completed, and the central office can initiate a separate authentication procedure or may rely on the authentication procedure performed by processor 160 at the network terminal.

Those skilled in the art will appreciate that the determination of whether the predetermined sequence (i.e., command) to initiate the remote diagnostic mode has been input can be performed at the network terminal, at the central office, or at both, and that an authentication procedure (if desired) can be performed independently at either location or at both locations. Regardless of the configuration selected as to where these functions are performed, the result is preferably that the network terminal and the central office be in synch concerning status when the network terminal is set in the remote diagnostic mode.

In the example embodiment described above, the remote diagnostic mode was initiated by a user at the network terminal (e.g., a service technician) inputting a predetermined DTMF sequence (such as 1.800.ONT.DIAG) using a handset connected to DTMF interface 200. Alternatively, the predetermined DTMF sequence (i.e., command) to initiate the remote diagnostic mode could be input using a keypad attached to or integrated directly into ONT 140, or by using a telephone connected to the POTS interface 210, or by using a computer or other device capable of generating DTMF signals that is connected to Ethernet interface 190, Wi-Fi interface 220, USB interface 230, or some other appropriate interface provided on the network terminal.

Further, the command to initiate the remote diagnostic mode is not limited to a DTMF sequence. For example, the command may also be a command entered using a computer connected to an Ethernet interface, Wi-Fi interface, USB interface, or the like provided on the network terminal (e.g., by accessing a webpage hosted on the network terminal). As a further example, the command could be input by contacting a central office (for example, using the POTS interface of the network terminal or a separate telephone) and verbally requesting that an operator at the central office transmit a command to set the network terminal in the remote diagnostic mode. As yet another example, the command may include a combination of signals input via different interfaces. One skilled in the art will appreciate that processor 160 can be configured and/or programmed to receive and analyze signals from any of these input interfaces to determine whether a command to initiate a remote diagnostic mode has been received and/or to transmit the received signals to the central office for such a determination.

Of course, a service technician can also use a conventional (i.e., local) diagnostic mode to access stored parameters and historical data that are stored locally at the network terminal. The conventional diagnostic mode can be used separate from or together with the remote diagnostic mode. A separate predetermined sequence and, if required, a separate authentication procedure can be used to initiate the conventional diagnostic mode independent of the remote diagnostic mode. Also, the hardware and/or software at the central office and/or the network terminal can be configured to enable access to conventional (i.e., local) diagnostic commands whenever the network terminal is set in the remote diagnostic mode.

When the network terminal is set in a diagnostic mode, a service technician can enter diagnostic commands that enable the technician to retrieve and examine parameters for the network terminal. If the set diagnostic mode is the remote diagnostic mode, the technician can access parameters stored remotely at the central office, and if the set diagnostic mode is only the conventional (local) diagnostic mode, the technician can only access parameters and/or data stored locally at the network terminal.

In this example embodiment, when the network terminal is set in a diagnostic mode, processor 160 causes a menu of available diagnostic commands to be displayed on a display of the technician's handset connected to DTMF interface 200. If the display has only a single line or a few lines, the technician can scroll through the commands to find the desired command and then select it (for example, by pressing the # key). When a diagnostic command is input, processor 160 analyzes the command to determine if it is a remote diagnostic command or a local diagnostic command. If it is a remote diagnostic command, processor 160 determines whether the network terminal is set in the remote diagnostic mode (for example, by checking a flag or a specific location in memory for a particular value). If the input command is a remote diagnostic command but the network terminal is not set in the remote diagnostic mode, an error message or other message can be displayed for the service technician to indicate that the input command is not available. Alternatively, the menu of commands displayed for the user can be modified in accordance with the diagnostic mode the network terminal is in, so that only the available commands are displayed.

As an alternative to displaying a menu of commands for selection by the service technician, the network terminal could be configured and/or programmed so that the service technician must simply enter a predetermined sequence of DTMF signals corresponding to a desired command (for example, the service technician could memorize the command codes or carry a card listing the various commands and their codes). As yet another alternative, if the service technician has a computer or other diagnostic tool connected to Ethernet interface 190, Wi-Fi interface 220, or USB interface 230, then processor 160 could cause a menu or a locally stored web page to be displayed on that device to permit the service technician to select a desired diagnostic command.

If the input diagnostic command is a local command, processor 160 retrieves the appropriate data and displays it for the technician. On the other hand, if it is a remote diagnostic command, processor 160 transmits the input command (e.g., DTMF signals) to the central office via bridge 150. At the central office, the appropriate software analyzes the command, determines whether the relevant network terminal is in the remote diagnostic mode, retrieves the information requested by the command, and transmits the appropriate information to the network terminal. Processor 160 controls the network terminal to cause the received information from the central office to be displayed for the service technician.

Examples of information that can be accessed by a service technician include information concerning alarm conditions that have occurred, statistical information such as the number of data packets sent to and/or received from a network interface of the network terminal, MAC address information, software versions, port settings, and information regarding services that are enabled or authorized for the network terminal and an associated end user. In addition, the network terminal and/or the central office can be configured and/or programmed to provide additional data related to a parameter being accessed. For example, if a diagnostic command is entered to query about the optical interface, the stored setting for the AGC gain may also be displayed.

In the present example embodiment, a service technician not only can access remotely stored configuration parameters, but can also push data from the network terminal to the central office to be stored, thereby changing centrally stored parameters for the network terminal. More specifically, the service technician inputs a command to change a parameter stored at the central office, together with information identifying the parameter and the value of the parameter to be stored. In order to provide strict control and security over this function, in this example embodiment the technician is prompted to enter another password to confirm authorization to change centrally stored parameters. Alternatively, other authorization techniques including those discussed above can be implemented to provide multiple layers of security for this function. If processor 160 and/or software resident at the central office (for example, software in EMS 120) confirms authorization to change the centrally stored parameter, then the new value for the parameter is stored at the central office.

An example application of this function is as follows. A service technician responding to a customer report of a problem with internet service may determine that the Ethernet port is not functioning properly. After entering the remote diagnostic mode, the technician determines that the remotely stored parameter for the Ethernet port on the network terminal of interest indicates that the port is disabled. If the technician knows that the Ethernet port should be enabled (e.g., the customer has paid for the relevant service), the technician can remotely change the parameter to enable the Ethernet port.

In the example embodiment described above, the DTMF signals for initiating the remote diagnostic mode, as well as the diagnostic commands and information exchanged between the network terminal and the central office, are communicated over the same data channel. However, the present invention is not limited to that embodiment. For example, after the network terminal is set in the remote diagnostics mode, signals to be sent to the central office can be converted from analog signals to messages to be sent over the OMCI interface to the central office. In this alternative example embodiment, a notification signal is sent from the network terminal to OLT 110, using a specific PLOAM (physical layer OAM) message, to indicate that a command is waiting to be sent upstream. When OLT 110 receives the PLOAM message, it retrieves the command via the OMCI interface. If information from the central office is sent back to the network terminal using the OMCI channel, processor 160 converts the message back into a DTMF format for display on the service technician's caller ID device (or to another appropriate format for display to the technician). Also, it should be noted that signals being transmitted from the network terminal to the central office may be encrypted before transmission.

Also, in the example embodiment described above, when ONT 140 is set in the remote diagnostic mode, it maintains a communication channel between itself and the central office while it remains in a diagnostic mode (i.e., it maintains an off-hook condition). However, ONT 140 can also be configured and/or programmed to initiate an on-hook condition while it is in the diagnostic mode and it receives a predetermined signal (e.g., a predetermined DTMF diagnostic code entered by a service technician). For example, if the technician has completed using the remote diagnostic mode, entry of a particular code may terminate the connection between the network terminal and the central office but maintain the network terminal in a local diagnostic mode.

Further, ONT 140 can be configured and/or programmed so that, if it is in an on-hook state but still in the diagnostic mode, receipt of a predetermined signal (e.g., a predetermined DTMF diagnostic code entered by a service technician) can cause ONT 140 to re-initiate an off-hook condition and re-establish a communication channel with the central office. The re-initiation of the off-hook state may be with or without repeating an authentication procedure. This function allows the service technician to alternate between viewing locally stored parameters and viewing remotely stored parameters, to identify a mismatch, for example, without maintaining an off-hook state.

By providing a network terminal in accordance with the example embodiment described above, a service technician can perform diagnostics more efficiently by having access to examine configuration parameters and other information stored at a central office. Further, the technician can actually change parameters stored at the central office from the network terminal, thereby resolving problems more efficiently directly from the customer's location.

In addition, error messages or tones that are annoying to a technician can be avoided. With a conventional network terminal, if DTMF signals are input to perform local diagnostics, those signals may be passed up the channel to the central office. Since a switch does not recognize them as diagnostic commands, they may be treated as erroneous signals (for example, signals that do not correspond to a telephone number), and an error message or tone may be generated that is reproduced in a handset/headset of the service technician.

The above-discussed functionality of the software at the central office and at the network terminal may be provided by firmware or software and the software may be contained in a read-only memory installed in hardware, contained in a removable memory inserted into hardware, or may be transferred directly to a memory at the central office or at the network terminal via a wireless interface, an internet connection, or the like. Also, as mentioned above, the functionality may be provided by circuitry or other hardware rather than software.

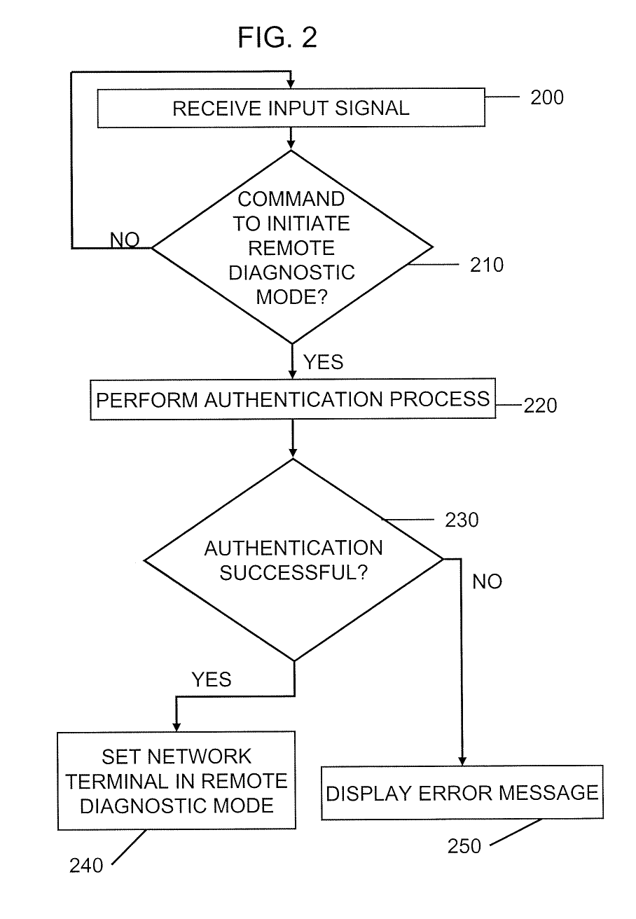

An example embodiment of a method to initiate a remote diagnostic mode will be described with respect to FIG. 2. In block 200, a signal that is input to a network terminal is received. In block 210, a determination is made as to whether the received signal corresponds to a command to initiate a remote diagnostic mode. In this example embodiment, the received signal is passed through to the central office and the determination in block 210 is performed at the central office. As discussed above, however, the invention is not limited to this embodiment. For example, the determination could be made at the network terminal, and the received signal could be transmitted to the central office only if the network terminal first determines that the received signal corresponds to a command to initiate a remote diagnostic mode.

If the received signal does not correspond to a command to initiate a remote diagnostic mode, then the procedure loops back to block 200 to await input of a further signal. If it is determined in block 210 that the received signal corresponds to a command to initiate a remote diagnostic mode, then in block 220 an authentication procedure is performed. In this example embodiment, the authentication procedure involves prompting the technician to enter two different passwords. In block 230, a determination is made as to whether the authentication procedure was completed successfully. If so, then in block 240 the network terminal is set in a remote diagnostic mode. In this example embodiment, setting the network terminal in the remote diagnostic mode includes storing information at the central office to indicate that the network terminal is in the remote diagnostic mode, and also transmitting a signal to the network terminal to cause a flag bit in a memory of the network terminal to be set to a value indicating that the network terminal is in the remote diagnostic mode.

If it is determined in block 230 that the authentication procedure was not completed successfully, then in block 240 an error message is displayed to inform the service technician that the authentication procedure was not successfully completed.

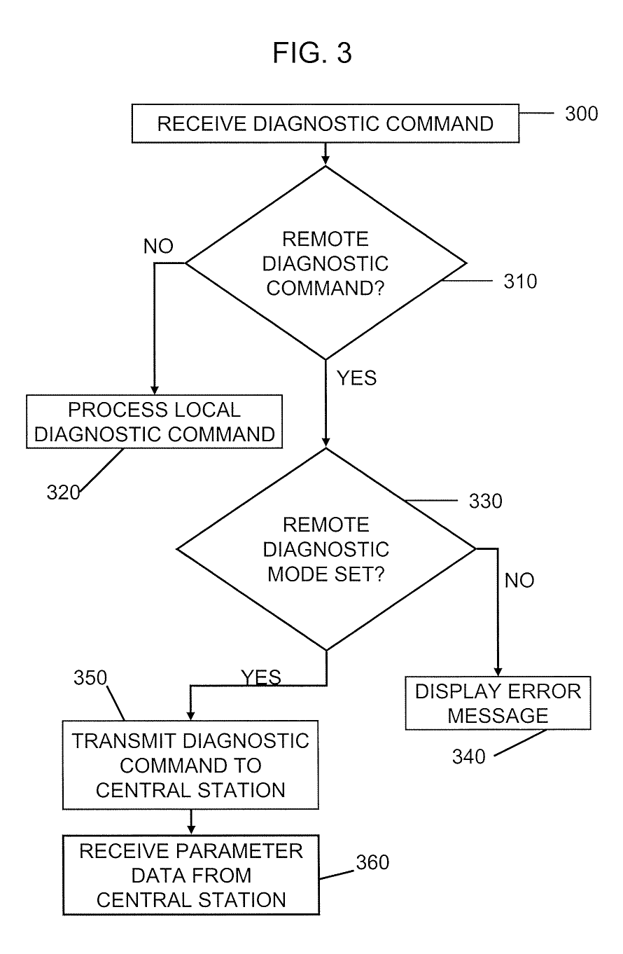

An example embodiment of a method to perform diagnostics in a network terminal will be described with respect to FIG. 3. In block 300, a diagnostic command is received at the network terminal. In this example embodiment, the command is input by selecting an entry from a menu. As discussed above, however, the command can be input by entering a DTMF sequence or using a computer or other device connected to an Ethernet interface, Wi-Fi interface, or USB interface, for example.

In block 310, a determination is made as to whether the received command is a remote diagnostic command. If not, then in block 320 the command is processed as a local diagnostic command. On the other hand, if it is determined in block 310 that the received command is a remote diagnostic command, then a determination is made in block 330 as to whether the network terminal is in the remote diagnostic mode. If not, then an error message is displayed in block 340, to inform the service technician that the network terminal is not in the remote diagnostic mode.

If it is determined in block 330 that the network terminal is in the remote diagnostic mode, then in block 350 the diagnostic command is transmitted to the central office. In block 360, information regarding a parameter stored at the central office is received at the network terminal in response to the diagnostic command transmitted in block 350. If the diagnostic command transmitted in block 350 was a command merely to view a stored parameter, then the information received in block 360 is merely the value of the stored parameter, which may then be displayed for the service technician. On the other hand, if the transmitted command was a command to change the value of a stored parameter, together with a new value for the parameter, then the information received in block 360 may be a confirmation that the value of the parameter has been changed at the central office. As an alternative example embodiment, if the command transmitted in block 350 is a command to change the value of a stored parameter, but the new value was not transmitted with the command, then the information received in block 360 may be a prompt to enter the new value for the stored parameter. The new value can then be received based on the service technician's input and transmitted to the central office to be stored.

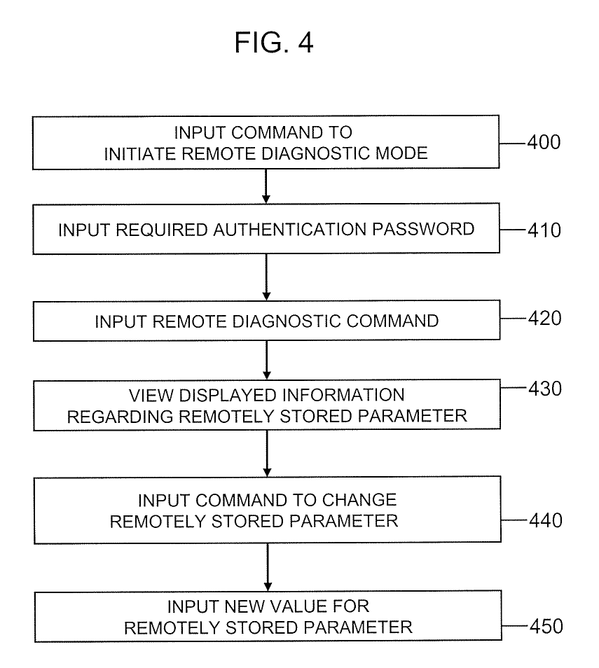

An example embodiment of a method to perform diagnostics for a network terminal will be described with respect to FIG. 4. In block 400, a user (e.g., a service technician) inputs a command to initiate a remote diagnostic mode in the network terminal. In this example embodiment, the command is input by inputting a predetermined DTMF sequence (e.g., corresponding to 1.800.ONT.DIAG). However, the command can be input in other ways. For example, the user can input the command to initiate the remote diagnostic mode by issuing a command from a computer or other device connected to an Ethernet interface, Wi-Fi interface, or USB interface of the network terminal, or by interacting with a webpage hosted on the network terminal. Further, the user can input the command by verbally requesting (e.g., using a POTS interface on the network terminal or a separate telephone) that an operator at a central office transmit a signal to set the network terminal in a remote diagnostic mode.

In block 410, the user enters a password to successfully complete an authentication procedure required to enter the remote diagnostic mode. In block 420, the user inputs a remote diagnostic command, and in block 430 the user views the parameter value displayed in response to the remote diagnostic command.

In block 440, the user inputs a command to change a remotely stored parameter value, and in block 450, the user inputs a new value for the parameter to be changed.

According to another example aspect of the invention, information regarding who is entering into the diagnostic mode, as well as information about the particular diagnostics they perform can be collected. In one example embodiment of the invention, logging begins when a network terminal is set in a diagnostic mode (this can be either the local diagnostic mode or the remote diagnostic mode). The logging records in a memory information such as the diagnostic commands entered and/or the parameters viewed. Information identifying the technician who initiated the diagnostic mode and/or information identifying the specific network terminal may be included in the log. The log may be recorded, for example, in a flash memory in ONT 140. If the network terminal is in a remote diagnostic mode, the logged commands can be stored in memory at the central office, since the commands are transmitted to the central office to retrieve and/or change parameters stored at the central office.

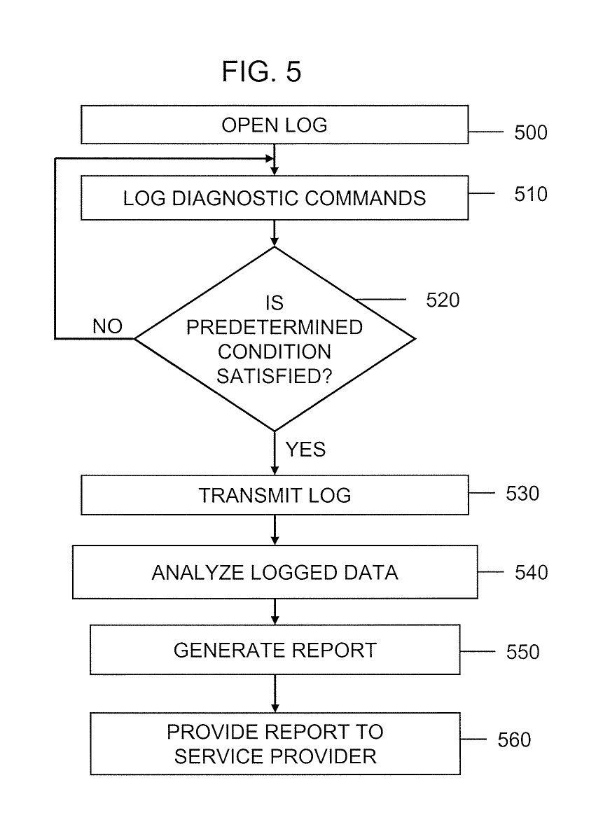

An example embodiment of a method to collect diagnostic information from a network terminal will be described with respect to FIG. 5. In block 500, a log is opened. This may be done, for example, when the network terminal is set in a diagnostic mode, and initial information identifying the network terminal and/or the service technician who initiated the diagnostic mode may be recorded in the log. Alternatively, a continuous log may be kept that extends over multiple diagnostic mode sessions. Older entries in the log can be deleted once that information has been transmitted to the central office or after being stored for a predetermined amount of time.

In block 510, diagnostic commands entered into the network terminal (and/or diagnostic scripts accessed by the service technician) are recorded in the log. In block 520, a determination is made as to whether a predetermined condition is satisfied for transmitting the log to the central office. In this example embodiment, the predetermined condition is when the network terminal re-ranges. Other conditions are possible. For example, the log can be transmitted periodically (e.g., every two minutes after entering a diagnostic mode, or after every five new entries recorded in the log) or at a predetermined time (e.g., a specific time and day of the week). If it is determined that the predetermined condition is not satisfied, then flow returns to block 510 to log further commands.

If it is determined in block 520 that the predetermined condition is satisfied, then in block 530 the log is transmitted to the central office. The log information can be transmitted via the diagnostics channel or over the OMCI channel, and the log information can be encrypted if desired before transmission. Also, as mentioned above, in an alternate example embodiment the diagnostic commands relating to the remote diagnostic mode can be logged at the central office as they are received from the network terminal.

In block 540, analysis or processing of the logged diagnostic information is performed. In this example embodiment, this analysis includes generating statistics for multiple network terminals regarding the different commands being entered in a diagnostic mode. The frequently used commands can be correlated to particular problems being diagnosed. For example, if the video signal level is often being queried in certain network terminals, this may indicate that modifications to certain splitters or other equipment should be made to improve performance and to minimize the number of times that the video signal level parameter must be checked. The logged diagnostic commands can also be correlated with other information, such as the types of network terminals installed, the geographic location of the network terminals, the services that are enabled on the network terminals, etc.

In block 550, a report is generated based on the analyzed log data. The report can be customized to a desired format and to include information regarding a particular network terminal or group of network terminals, or statistical information regarding particular diagnostic commands, particular types of network terminals, network terminals having certain services enabled, etc. In block 560, the generated report is provided to a service provider. The service provider can use the report to troubleshoot network problems, improve current or future networks by adjusting parameters or otherwise addressing frequently occurring issues, etc.

Although this invention has been described in certain specific example embodiments, many additional modifications and variations would be apparent to those skilled in the art. It is therefore to be understood that this invention may be practiced otherwise than as specifically described. The specification and drawings are accordingly to be regarded in an illustrative rather than in a restrictive sense. It will, however, be evident that various modifications and changes may be made thereto, in a computer program product or software, hardware, or any combination thereof, without departing from the broader spirit and scope of the present invention. Thus, the present embodiments of the invention should be considered in all respects as illustrative and not restrictive, the scope of the invention to be determined by any claims supportable by this application and the claims' equivalents rather than the foregoing description.

Software embodiments of the present invention may be provided as a computer program product, firmware, or software, that may include an article of manufacture on a machine accessible or machine readable medium (memory) having instructions. The instructions on the machine accessible or machine readable medium may be used to program a computer system or other electronic device. The machine-readable medium may include, but is not limited to, floppy diskettes, optical disks, CD-ROMs, and magneto-optical disks or other types of media/machine-readable medium suitable for storing or transmitting electronic instructions. The techniques described herein are not limited to any particular software configuration. They may find applicability in any computing or processing environment. The terms “machine accessible medium,” “computer readable medium” or “machine readable medium” used herein (if at all) shall include any medium that is capable of storing, encoding, or transmitting a sequence of instructions for execution by the machine and that cause the machine to perform any one of the methods described herein. Furthermore, it is common in the art to speak of software, in one form or another (e.g., program, procedure, process, application, module, unit, logic, and so on) as taking an action or causing a result. Such expressions are merely a shorthand way of stating that the execution of the software by a processing system causes the processor to perform an action to produce a result. In other embodiments, functions performed by software can instead be performed by hardcoded modules, and thus the invention is not limited only for use with stored software programs.

In addition, it should be understood that the figures illustrated in the attachments, which highlight the functionality and advantages of the present invention, are presented for example purposes only. The architecture of the present invention is sufficiently flexible and configurable, such that it may be utilized (and navigated) in ways other than that shown in the accompanying figures.

Furthermore, the purpose of the Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way. It is also to be understood that the procedures recited in the claims need not be performed in the order presented.

We claim:

1. A method to initiate a remote diagnostic mode in a network terminal, comprising:
determining whether a received signal corresponds to a command to initiate a remote diagnostic mode; and
setting the network terminal in a remote diagnostic mode in accordance with the result of the determining.

2. The method according to claim 1, wherein the determining comprises comparing a signal received via at least one of a DTMF interface, an Ethernet interface, a USB interface, and a Wi-Fi interface to stored information to determine whether the received signal corresponds to a command to initiate a remote diagnostic mode.

3. The method according to claim 1, wherein the determining comprises transmitting a signal input to the network terminal to a central office and determining at the central office whether the received signal corresponds to a command to initiate a remote diagnostic mode.

4. The method according to claim 3, wherein the setting comprises storing an indication that the network terminal is in the remote diagnostic mode in response to a signal received at the network terminal from the central office.

5. The method according to claim 1, wherein the setting comprises storing an indication that the network terminal is in the remote diagnostic mode at the network terminal and storing an indication that the network terminal is in the remote diagnostic mode at a central office.

6. The method according to claim 1, wherein the setting comprises performing an authentication procedure if the received signal is determined to correspond to a command to initiate a remote diagnostic mode and setting the network terminal in a remote diagnostic mode if the authentication procedure is completed successfully.

7. The method according to claim 1, wherein the determining is performed at the network terminal and, if it is determined that the received signal corresponds to a command to initiate a remote diagnostic mode, the received signal is transmitted to a central office.

8. A method to perform diagnostics in a network terminal, comprising:
determining whether a diagnostic command received at the network terminal is a remote diagnostic command;
if the received diagnostic command is determined to be a remote diagnostic command, determining whether the network terminal is in a remote diagnostic mode; and
if the network terminal is determined to be in the remote diagnostic mode, transmitting the received diagnostic command to a central office.

9. The method according to claim 8, further comprising displaying information received from the central office in response to the transmitted diagnostic command.

10. The method according to claim 9, wherein the displaying comprises displaying values for one or more configuration parameters related to the network terminal.

11. The method according to claim 8, further comprising:
transmitting information to the central office to modify one or more configuration parameters related to the network terminal; and
modifying the one or more configuration parameters at the central office based on the transmitted information.

12. A method to perform diagnostics for a network terminal, comprising:
inputting a command to initiate a remote diagnostic mode for the network terminal;
inputting a diagnostic command to retrieve configuration data for the network terminal from a central office; and
viewing displayed information representing the configuration data for the network terminal retrieved from the central office.

13. A method according to claim 12, wherein inputting a command comprises entering a predetermined DTMF sequence into the network terminal.

14. A method according to claim 12, further comprising performing an authentication procedure.

15. A method according to claim 12, further comprising inputting configuration parameter data to be stored at the central office.

16. A network terminal comprising:
a bridge to interface the network terminal with a data channel linking the network terminal to a central office;
an interface to receive DTMF signals; and
a processor to (i) analyze received DTMF signals, (ii) determine whether the received DTMF signals correspond to a command to initiate a remote diagnostic mode, and (iii) transmit the received DTMF signals to the central office via the bridge.

17. A network terminal according to claim 16, wherein the processor transmits the received DTMF signals to the central office only if the processor determines that the received DTMF signals correspond to a command to initiate a remote diagnostic mode.

18. A network terminal according to claim 16, wherein, if the processor determines that the received DTMF signals correspond to a command to initiate a remote diagnostic mode, the processor performs an authentication procedure and, if the authentication procedure is completed successfully, the processor sets the network terminal in a remote diagnostic mode.

19. A network terminal according to claim 16, wherein the processor sets the network terminal in a remote diagnostic mode in accordance with a signal received from the central office.

20. A network terminal according to claim 16, wherein the processor determines whether the network terminal is set in a remote diagnostic mode and transmits received DTMF signals to the central office if the network terminal is set in a remote diagnostic mode.

21. A method to collect diagnostic information for network terminals, comprising:
logging diagnostic commands input at a network terminal; and
generating a report at a central office based on the logged diagnostic commands.

22. A method according to claim 21, further comprising providing the generated report to a service provider.

23. A method according to claim 21, wherein the logging is performed at the central office for diagnostic commands input at a network terminal and transmitted to the central office when the network terminal is in a remote diagnostic mode.

24. A method according to claim 21, wherein the logging is performed by storing the input diagnostic commands in memory at the network terminal and transmitting the logged diagnostic commands to the central office.

25. A method according to claim 21, wherein the generating comprises analyzing the number of times various diagnostic commands are input at different network terminals.
